(19) United States
(12) Patent Application Publication
(10) Pub. No.: US 2003/0235314 A1
(43) Pub. Date: Dec. 25, 2003

(54) Audio system with wireless speakers

(76) Inventor: Yu-Hsiang Wang, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/413,085

(22) Filed: Apr. 14, 2003

(30) Foreign Application Priority Data
Jun. 21, 2002 (TW) 091113657

(51) Int. Cl. H04H 5/00; H04B 3/00; H04B 5/00

(52) U.S. Cl. 381/79; 381/77; 381/2

(57) ABSTRACT

An audio system with wireless speakers eliminates the long audio signal transmission lines between the amplifier and speakers. Sending the radio frequency signal from the amplifier to speakers utilizes wireless communication technique. Therefore, the problems in moving, assembling, and setting up the audio system can be solved.

### FIELD OF THE INVENTION

The present invention relates to an audio system, and more particularly, the present invention relates to an audio system with wireless speakers.

### BACKGROUND OF THE INVENTION

With the development and improvement of the technology, the quality of life becomes more and more important for most people. An audio system is one of the indices of better life, and almost becomes a necessity in a family. Due to the demands of high audio quality and user-friendly operation, storage media of music data evolves gradually from early discs, tapes to laser discs nowadays. Furthermore, quality of speakers also plays an important role for the development and improvement of an audio system.

Referring to FIG. 1, a basic structure of a conventionally audio system is illustrated. The system includes a host machine 100. The host machine 100 includes a radio 105, a player 110, a radio antenna 115, and a speaker 120. The frequency modulation (FM) or amplitude (AM) signal radiating in the air is received by the radio 105 via the radio antenna 115. The electromagnetic signal then demodulated into audio data. The demodulated audio data are sent to the speaker 120 to sound. Alternatively, the speaker 120 may sound the audio data stored in a tape or disc and picked up by the player 110.

As the progress of the technology, demand of a high quality audio system becomes severe. The conventional basic audio systems cannot be satisfied by people anymore. In order to improve the quality of the audio system, design of speakers becomes even more complicated. The quantity and the arrangement of speakers are also taken into consideration as important issues. To improve the quality of output sound and to enrich the music, an amplifier is additionally provided to process audio data.

Referring to FIG. 2, an improved audio system includes a host machine 200, a group of speakers 220, and audio signal transmission lines 225. The host machine 200 includes a radio 205, a player 210, a radio antenna 215, and an amplifier 230 in the same housing. The FM or AM signal radiating in the air is received by the radio 205 via the radio antenna 215. Such a signal should be transferred into audio data by using a special demodulation technology. The demodulated audio data is sent to the amplifier 230 to be further processed in order to enhance its quality. Then, the quality-enhanced audio data is transmitted to the speakers 220. Alternatively, the audio data stored in a tape or in a disc can be read and sent to the amplifier 230 where the quality of the audio data can be enhanced by the player 210.

Referring to FIG. 3, another improved audio system includes a host machine 300, a group of speakers 320, and audio signal transmission lines 325. The host machine 300 includes a radio 305, a player 310 and a radio antenna 315. The audio system further includes an amplifier 330 separate from the host machine 300. For both of the audio systems shown in FIGS. 2 and 3, audio signal transmission lines 325 are required for communicating the speakers with the amplifier 230 or 330. Because of the specific position of speakers, audio data must be transmitted from the amplifier to each speaker via respective long signal transmission lines that might result in inconvenience and problems in moving, assembling or setting up. In addition, these long audio signal transmission lines are unpleasant to the eye.

### SUMMARY OF THE INVENTION

It is therefore an objective of this invention to provide an audio system with wireless speakers. The audio system with wireless speakers mainly eliminates the long audio signal transmission lines between the amplifier and speakers. Sending the audio data from the amplifier to speakers utilizes wireless communication technique. In this way, the present invention can solve the inconvenience in moving, assembling, and setting up of the audio system.

In accordance with the object of this invention, this invention provides an audio system with wireless speakers, which is described as follows.

The audio system comprises an audio data transmitter for modulating an audio data to a radio frequency signal; an audio data transmission antenna coupled to the audio data transmitter for radiating the radio frequency signal in the air; an audio data receiving antenna for receiving the radio frequency signal; an audio data receiver coupled to the audio data receiving antenna for demodulating the radio frequency to the audio data; and a speaker coupled to the audio data receiver for sounding the audio data.

The audio data transmitter is preferably mounted on the amplifier of the audio system, and the audio data receiver is mounted on each of the wireless speakers.

In another aspect of the present invention, the audio system includes a host machine for generating an audio data; an amplifier for receiving and transferring the audio data into a radio frequency signal; and at least one wireless speaker including an audio data receiving antenna, an audio data receiver, and a speaker. The audio data receiving antenna receives the radio frequency signal in the air, the audio data receiver transforms the radio frequency signal into an analog audio data signal, and the speaker sounds the analog audio data signal.

### BRIEF DESCRIPTION OF THE DRAWINGS

The invention will be more fully understood from the detailed description given herein below and the accompanying drawing, which are given by way of illustration only, and thus do not limit the present invention, and wherein:

FIG. 1 shows a conventional basic audio system;

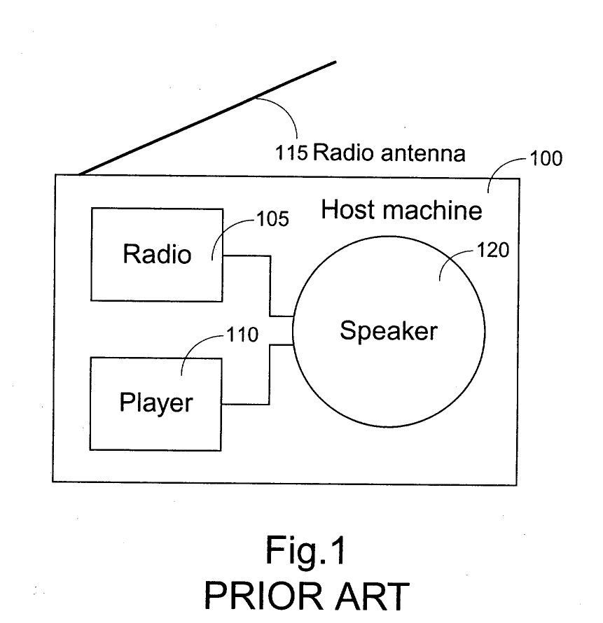

FIG. 2 shows a conventional audio system with wired speakers;

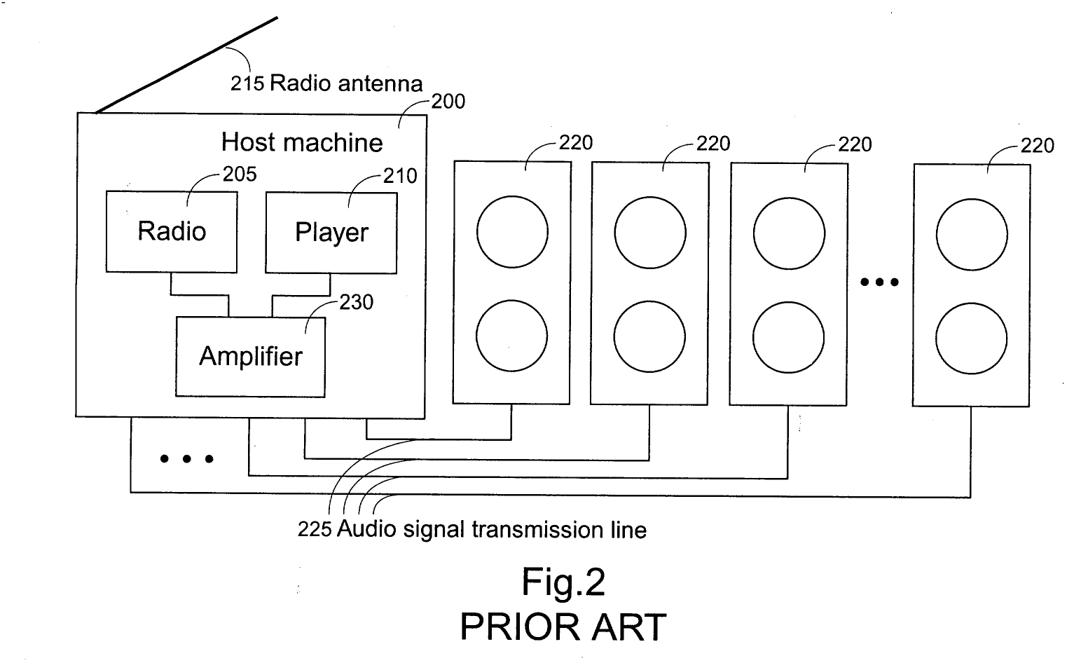

FIG. 3 shows another conventional audio system with wired speakers;

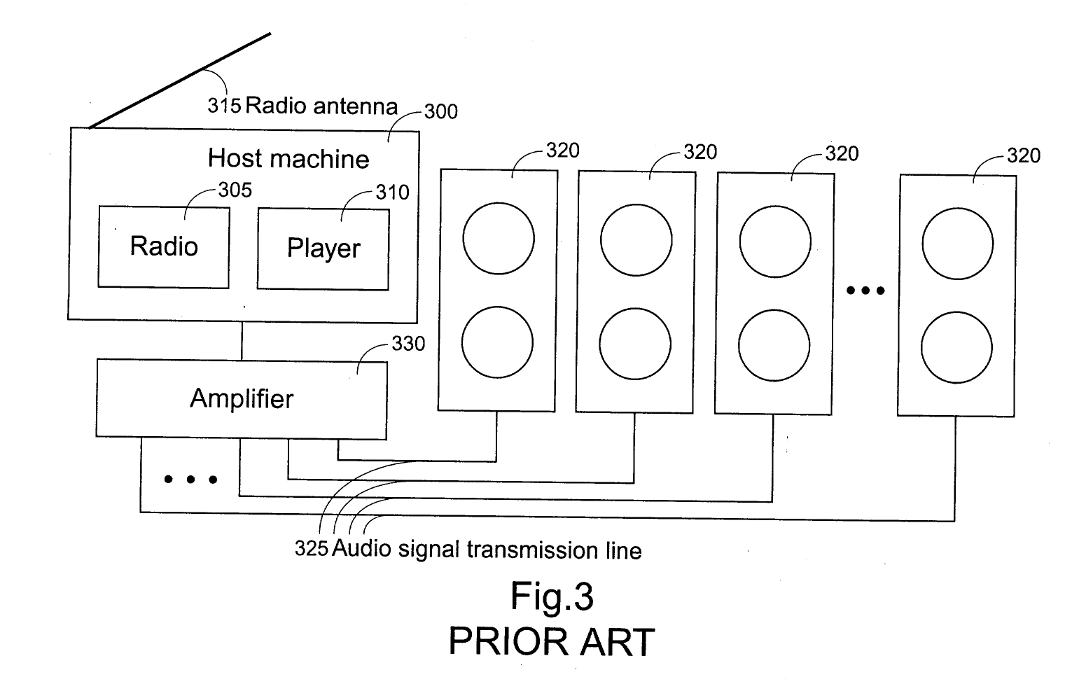

FIG. 4 shows an embodiment of an audio system with wireless speakers according to the present invention;

FIG. 5 shows the constellation of Quadrature Phase Shift Keying;

FIG. 6 shows a structure of the radio frequency circuit of the audio data transmitter of FIG. 4; and

FIG. 7 shows a structure of the radio frequency circuit of the audio data receiver of FIG. 4.

### DESCRIPTION OF THE PREFERRED EMBODIMENT

Because of necessarily using several long audio signal transmission lines, it might result in inconvenience and some problems in moving or setting up the audio system. Therefore, an audio system with wireless speakers is introduced in this invention.

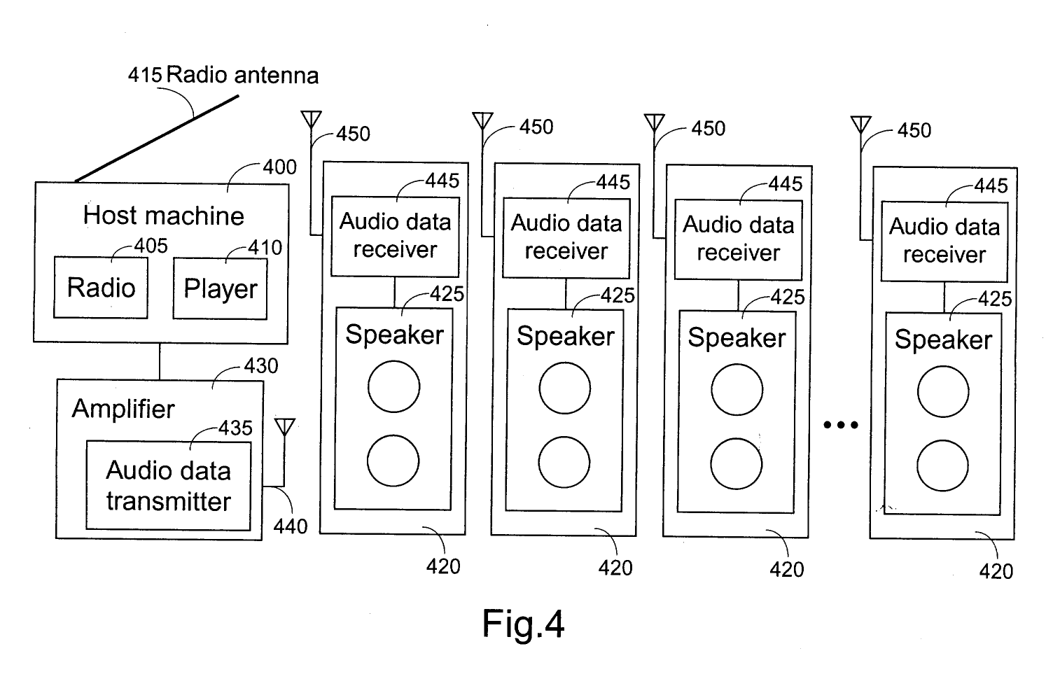

FIG. 4 shows an embodiment of the present invention. An audio system with wireless speakers includes a host machine 400, an amplifier 430, and a group of wireless speakers 420. The host machine 400 consists of a radio 405, a player 410, and a radio antenna 415. Each of the wireless speakers 420 includes a speaker 425, an audio data receiver 445, and an audio data receiving antenna 450. The amplifier 430 includes an audio data transmitter 435 and an audio data transmission antenna 440.

The radio 405 receives FM or AM radio frequency signal via its radio antenna 415. The FM or AM radio frequency signal would be transformed to an audio data by using a special modulation technology and transferred to the amplifier 430. Optionally, the audio data stored in a tape or in a disc can be read and sent to the amplifier 430 by the player 410. The quality of the audio data is processed and improved in the amplifier 430. Subsequently, the audio data would be up-converted to a radio frequency signal in the audio data transmitter 435.

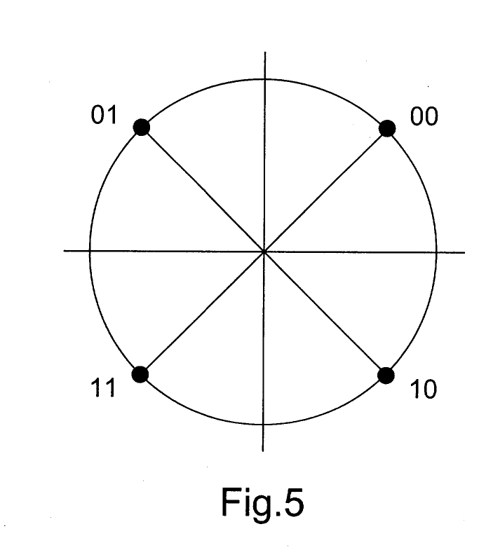

In this embodiment, the audio data processed by the amplifier 430 is a series of digital signals so that Quadrature phase shift-keying (QPSK) modulation is chosen to modulate the audio data in the audio data transmitter 435. Using this kind of modulation technology, each bite is represented by the phase of the continuous analog signal. As shown in FIG. 5, forty-five degree phase represents the bite “00”, one hundred thirty five degree phase represents the bite “01”, two hundred twenty five degree phase represents the bite “11”, and three hundred and fifteen degree phase represents the bite “10”.

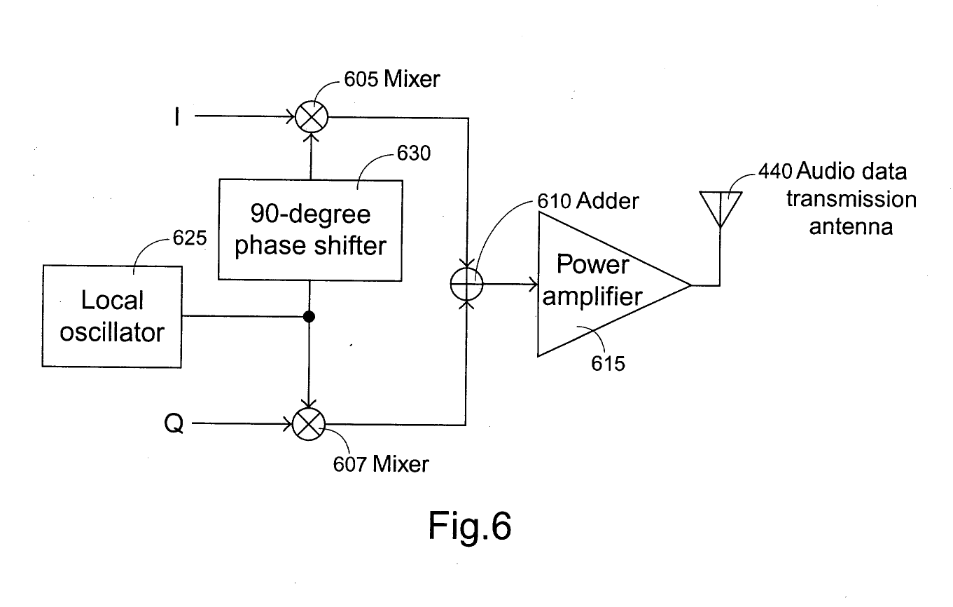

The structure of the audio data transmitter 435 is shown in FIG. 6. Direct-Conversion is chosen to up-convert the audio data from base band to radio frequency band via only once mixing. Referring to FIG. 6, the local oscillator 625 generates a sinusoidal signal whose frequency is the same as the frequency of the radio frequency signal. Two signals generated by the QPSK modulation in base band, so called an I signal and a Q signal, whose phases connote the series data are mixed with the sinusoidal signal by the two mixers 605 and 607 individually. The phase of the sinusoidal signal has to be 90-degree-shifted by a 90-Degree Phase Shifter 630 before mixing in the mixer 605. Then, the outputs of two mixers are merged by using an adder 610. This radio frequency signal in the output of the adder 610 is amplified by using a power amplifier 615. Finally, it is radiated in the air by a audio data transmission antenna 440.

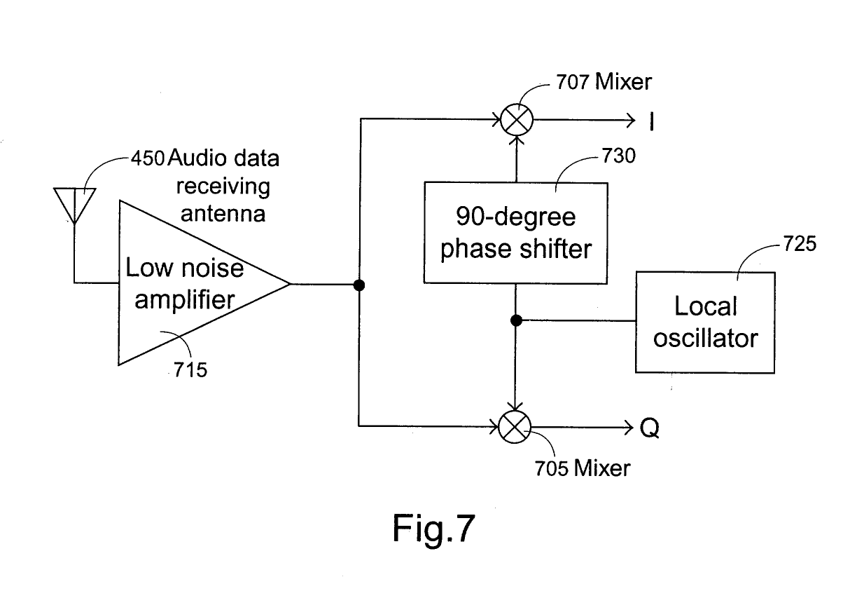

Referring FIG. 4 again, on the other side, each audio data receiving antenna 450 in the wireless speakers 420 receives the radio frequency signal from the audio data transmission antenna 440 instantly. The structure of the audio data receiver 445 is shown in FIG. 7, and the same technology is chosen again to demodulate the signal from radio frequency band to base band by only once mixing. Referring to FIG. 7, because the radio frequency signal received by audio data receiving antenna 450 is very weak, it has to be amplified by a low noise amplifier 715. Then, this amplified radio frequency signal is divided into two amplified radio frequency signals and sent into the two mixers 705 and 707 individually. The sinusoidal signal generated by a local oscillator 725 is respectively mixed with these two amplified radio frequency signals by the two mixers 705 and 707. Before mixing in the mixer 707, the phase of the sinusoidal signal has to be adjusted by 90 degrees with a 90-degree phase shifter 730. The amplified radio frequency signals and sinusoidal signals must be in phase, and then I signal and Q signal in base band can be obtained.

Referring to FIG. 4, original audio data can be obtained via the audio data receiver 445. Then, such a digital audio data must be transferred to an analog audio data and sent to speakers 425.

Taking advantage of this invention, long audio signal transmission lines between the amplifier and speakers are unnecessary. It also solves the problems in moving, assembling, or setting up the audio system with wired speakers.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An audio system with wireless speakers, comprising:
an audio data transmitter modulating an audio data to a radio frequency signal;
an audio data transmission antenna coupled to said audio data transmitter, and radiating said radio frequency signal;
an audio data receiving antenna receiving said radio frequency signal;
an audio data receiver coupled to said audio data receiving antenna, and demodulating said radio frequency signal to said audio data; and
a speaker coupled to said audio data receiver for sounding the audio data.

2. The audio system with wireless speakers according to claim 1 wherein said audio data is a digital data.

3. The audio system with wireless speakers according to claim 2 wherein said audio data transmitter uses a QPSK modulation protocol to generate said radio frequency signal.

4. The audio system with wireless speakers according to claim 1 wherein said audio data transmitter comprises:
a local oscillator generating a sinusoidal signal;
a ninety-degree phase shifter shifting the sinusoidal signal by substantially 90 degrees;
a first mixer mixing a first signal in base band and said sinusoidal signal;
a second mixer mixing a second signal in base band and said 90-degree-shifted sinusoidal signal;
an adder combining the outputs of said first mixer and said second mixer; and
a power amplifier enhancing the output of said adder.

5. The audio system with wireless speakers according to claim 1 wherein said audio data receiver comprises:
a low noise amplifier amplifying said radio frequency signal received by said audio data receiving antenna;
a local oscillator generating a sinusoidal signal;
a ninety-degree phase shifter shifting said sinusoidal signal by 90 degrees;
a first mixer mixing said amplified radio frequency signal and said sinusoidal signal; and
a second mixer mixing said amplified radio frequency signal and said 90-degree-shifted sinusoidal signal.

6. The audio system with wireless speakers according to claim 1 wherein said audio data transmitter is mounted on an amplifier of said audio system, and said audio data receiver is mounted on each of said wireless speakers.

7. An audio system with wireless speakers comprising:
a host machine generating an audio data;
an amplifier receiving and transferring said audio data into a radio frequency signal; and
at least one wireless speaker, including an audio data receiving antenna, an audio data receiver, and a speaker;
wherein said audio data receiving antenna receives said radio frequency signal in the air, said audio data receiver transforms said radio frequency signal into an analog audio data signal, and said speaker sounds said analog audio data signal.

8. The audio system with wireless speakers according to claim 7 said amplifier comprises an audio data transmitter and an audio data transmission antenna, wherein said audio data transmitter up-converts said audio data in base band into said radio frequency signal, and said audio data transmission antenna radiates said radio frequency signal.

9. The audio system with wireless speakers according to claim 8 wherein said audio data transmitter comprises:
a local oscillator generating a sinusoidal signal;
a ninety-degree phase shifter shifting the sinusoidal signal by substantially 90 degrees;
a first mixer mixing a first signal in base band and said sinusoidal signal;
a second mixer mixing a second signal in base band and said 90-degree-shifted sinusoidal signal;
an adder combining the outputs of said first mixer and said second mixer; and
a power amplifier enhancing the output of said adder.

10. An audio system with wireless speakers according to claim 7 wherein the audio data receiver comprises:
a low noise amplifier amplifying said radio frequency signal received by said audio data receiving antenna;
a local oscillator generating a sinusoidal signal;
a ninety-degree phase shifter shifting said sinusoidal signal by 90 degrees;
a first mixer mixing said amplified radio frequency signal and said sinusoidal signal; and
a second mixer mixing said amplified radio frequency signal and said 90-degree-shifted sinusoidal signal.

11. The audio system with wireless speakers according to claim 7 wherein the host machine comprises a radio and a player.
